(19) United States
(12) Patent Application Publication
(10) Pub. No.: US 2025/0309260 A1
(43) Pub. Date: Oct. 2, 2025

(54) POSITIVE ELECTRODE ACTIVE MATERIAL, LITHIUM ION SECONDARY BATTERY AND METHOD FOR MANUFACTURING POSITIVE ELECTRODE ACTIVE MATERIAL

(71) Applicant: HONDA MOTOR CO., LTD., Tokyo (JP)

(72) Inventors: Takashi HAKARI, Saitama (JP); Kazumasa SAKATSUME, Saitama (JP); Kazuki CHIBA, Saitama (JP); Akihisa TANAKA, Saitama (JP); Yoshiyuki MORITA, Saitama (JP)

(21) Appl. No.: 19/051,551

(22) Filed: Feb. 12, 2025

(30) Foreign Application Priority Data
Mar. 29, 2024 (JP) 2024-057100

(51) Int. Cl. H01M 4/58; C01G 49/10; H01M 4/02; H01M 10/0525

(52) U.S. Cl. CPC H01M 4/582; H01M 10/0525; C01G 49/10; H01M 2004/028

(57) ABSTRACT

There is provided a positive electrode active material containing a lithium-iron composite fluoride as a principal component, wherein the lithium-iron composite fluoride is represented by the following formula (1):

LiₓFeF₍₃₊ₓ₎ (1)
where, in formula (1), x is a number satisfying 0.4≤x<1.5.

### BACKGROUND

### Technical Field

The present invention relates to a positive electrode active material, a lithium ion secondary battery, and a method for manufacturing the positive electrode active material.

### Related Art

In recent years, research and development on a secondary battery that contributes to energy efficiency has been conducted in order for more people to be able to access affordable, reliable, sustainable, and advanced energy. In particular, a lithium ion secondary battery is becoming increasingly important as a power source for an electric vehicle (EV), a hybrid electric vehicle (HEV), or the like.

A positive electrode active material has attracted attention as an important component for determining a capacity of a lithium ion secondary battery, and development thereof has been advanced. As a positive electrode active material used for a lithium ion secondary battery, for example, iron (Fe)-based lithium iron phosphate (LiFePO₄) with low resource risk is known. LiFePO₄ is excellent in cycle characteristics and safety, but has a low voltage and a small capacity. Therefore, an energy density (voltage×capacity) represented by a product of the voltage and the capacity is small as compared with a conventionally used material based on nickel (Ni) or cobalt (Co). In order to construct a small battery, an electrode material with a high energy density is required, and in order to realize the high energy density, a high-voltage operation of a battery is important.

For the purpose of increasing the voltage of a battery using a material containing an element with low resource risk, use of a high-valent transition metal (for example, not Fe²⁺⇔Fe³⁺ but Fe³⁺⇔Fe⁴⁺) is expected. However, Fe⁴⁺ is very unstable and becomes Fe³⁺ by side reaction, or Fe⁴⁺ requires a very large amount of energy and does not be generated in some cases. Thus, even though a Fe³⁺ compound is used as the positive electrode active material, it is not necessarily capable of operating at a high voltage.

For example, it has been reported in F. Badway, et al., “Carbon Metal Fluoride Nanocomposites” J. Electrochem. Soc., 150(10) A1318-A1327 (2003) that LiFeF₃ is generated during charge and discharge by using ferric fluoride (FeF₃), and an average discharge voltage is 3.1 V. It has been reported in Y. Hu, et al., “A Simple, Quick and Eco-friendly strategy of Synthesis Nanosized α-LiFeO₂ Cathode with Excellent Electrochemical Performance for Lithium-Ion Batteries” Materials, 11, 1176 (2018) that LiFeO₂ can be expected to have a high energy density.

### CITATION LIST

### Non Patent Literatures

Non Patent Literature 1: F. Badway, et al., “Carbon Metal Fluoride Nanocomposites” J. Electrochem. Soc., 150(10) A1318-A1327 (2003)
Non Patent Literature 2: Y. Hu, et al., “A Simple, Quick and Eco-Friendly Strategy of Synthesis Nanosized α-LiFeO₂ Cathode with Excellent Electrochemical Performance for Lithium-Ion Batteries” Materials, 11, 1176 (2018)

### SUMMARY

In Y. Hu, et al., “A Simple, Quick and Eco-friendly strategy of Synthesis Nanosized α-LiFeO₂ Cathode with Excellent Electrochemical Performance for Lithium-Ion Batteries” Materials, 11, 1176 (2018), an actual voltage is about 2.5 V, which is lower than an expected voltage. The average discharge voltage (3.1 V) described in F. Badway, et al., “Carbon Metal Fluoride Nanocomposites” J. Electrochem. Soc., 150(10) A1318-A1327 (2003) is also lower than a voltage of LiFePO₄, and there is room for improvement in order to further increase the voltage.

The present invention has been made in order to solve the above problems, and an object thereof is to provide an Fe-based positive electrode active material capable of operating at a high voltage, a lithium ion secondary battery containing the positive electrode active material, and a method for manufacturing the positive electrode active material. Furthermore, an additional object thereof is to reduce resource risk and contribute to cost reduction.

In order to achieve the above-described objects, the present invention provides the following methods.

[1] A positive electrode active material containing a lithium-iron composite fluoride as a principal component, wherein the lithium-iron composite fluoride is represented by the following formula (1):

LiₓFeF₍₃₊ₓ₎ (1)
where, in formula (1), x is a number satisfying 0.4≤x<1.5.

The positive electrode active material according to [1] has a high average discharge voltage and can operate at a high voltage. Therefore, in a lithium ion secondary battery containing the positive electrode active material, the number of batteries required can be reduced, thereby contributing to cost reduction.

[2] The positive electrode active material according to [1], wherein in the above formula (1), x satisfies 0.4≤x<1.0.

The positive electrode active material according to [2] has a higher average discharge voltage and can operate at a higher voltage. Therefore, the positive electrode active material can contribute to further cost reduction.

[3] The positive electrode active material according to [1] or [2], having peaks in a range of 20°≤2θ<25° and a range of 25°≤2θ≤30° in an X-ray diffraction pattern.

The positive electrode active material according to [3] has a peak derived from a crystal structure of FeF₃ and a peak derived from a crystal structure of LiFe₂F₆.

[4] The positive electrode active material according to any one of [1] to [3], having peaks in a range of 20°≤2θ<25° and a range of 25°≤2θ≤30° in an X-ray diffraction pattern, wherein a diffraction intensity ratio (I_{LFF/FeF3}) represented by a maximum peak intensity in the range of 25°2θ≤30° to a maximum peak intensity in the range of 20°2θ<25° satisfies a relationship of the following formula (3):

I_{LFF/FeF3}=0.74x+b (3)
where, in formula (3), x represents a number satisfying 0.4≤x<1.0 in the above formula (1), and b represents a number satisfying b>0.46.

The positive electrode active material according to [4] can increase a capacity of a lithium ion secondary battery containing the positive electrode active material, and can further increase an energy density.

[5] A lithium ion secondary battery including a positive electrode, a negative electrode, and an electrolyte, wherein the positive electrode contains the positive electrode active material according to any one of [1] to [4].

In the lithium ion secondary battery according to [5], the positive electrode contains the positive electrode active material according to any one of [1] to [4]. This indicates that the battery can operate at a high voltage.

[6] The lithium ion secondary battery according to [5], wherein a dQ/dV plot during discharge in a charge-discharge cycle has a peak in a range of 3.77 to 4.0 V.

This indicates that, in the lithium ion secondary battery according to [6], the positive electrode active material undergoes a chemical reaction in a high voltage range of 3.77 to 4.0 V. This indicates that the battery can operate at a higher voltage.

[7] The lithium ion secondary battery according to [5] or [6], having an average discharge voltage of 3.8 to 4.0 V.

The lithium ion secondary battery according to [7] has a high average discharge voltage of 3.8 to 4.0 V. This indicates that the battery can operate at a high voltage.

[8] The lithium ion secondary battery according to any one of [5] to [7], wherein the electrolyte is a liquid electrolyte, a solid electrolyte, or a semi-solid electrolyte.

The lithium ion secondary battery according to [8] can be applied to any of a liquid electrolyte, a solid electrolyte, and a semi-solid electrolyte. Therefore, the lithium ion secondary battery can be applied to various types of batteries.

[9] The lithium ion secondary battery according to any one of [5] to [8], wherein the negative electrode is formed of metallic lithium or graphite.

The lithium ion secondary battery according to [9] can be applied to a battery in which a negative electrode is formed of metallic lithium or graphite. Therefore, the lithium ion secondary battery can be applied to various types of batteries.

[10]A method for manufacturing the positive electrode active material according to any one of [1] to [4], the method including a step of mixing a lithium source and an iron source, and subjecting the mixture to a mechanical treatment to obtain a lithium-iron composite fluoride.

The method for manufacturing the positive electrode active material according to [10] can provide a positive electrode active material having a high average discharge voltage and capable of operating at a high voltage. Therefore, in a lithium ion secondary battery containing the positive electrode active material, the number of batteries required can be reduced, thereby contributing to cost reduction.

[11] The method for manufacturing the positive electrode active material according to [10], further including a step of subjecting the lithium-iron composite fluoride to a heat treatment.

The method for manufacturing the positive electrode active material according to [11] can provide a positive electrode active material that increases a capacity of a lithium ion secondary battery and can further increase an energy density. Therefore, a capacity of a lithium ion secondary battery containing the positive electrode active material can be further increased, and an energy density can be further increased.

According to the present invention, it is possible to provide an Fe-based positive electrode active material capable of operating at a high voltage, and a lithium ion secondary battery containing the positive electrode active material.

### BRIEF DESCRIPTION OF DRAWINGS

FIG. 1 is a diagram illustrating an X-ray diffraction pattern of a positive electrode active material according to an embodiment of the present invention;

FIG. 2 is a cross-sectional view schematically illustrating a lithium ion secondary battery according to the embodiment of the present invention;

FIG. 3 is a graph illustrating a charge-discharge curve in a charge-discharge cycle of the lithium ion secondary battery according to the embodiment of the present invention;

FIG. 4 is a graph illustrating a dQ/dV plot in the charge-discharge cycle of FIG. 3;

FIG. 5 is a graph illustrating a dQ/dV plot in a charge-discharge cycle of a lithium ion secondary battery according to another embodiment of the present invention;

FIG. 6 is a diagram illustrating X-ray diffraction patterns of positive electrode active materials of Examples 1 to 5 and Comparative Example 1;

FIG. 7 is a graph illustrating a charge-discharge curve of a lithium ion secondary battery containing a positive electrode active material of Example 1;

FIG. 8 is a graph illustrating a charge-discharge curve of a lithium ion secondary battery containing a positive electrode active material of Example 2;

FIG. 9 is a graph illustrating a charge-discharge curve of a lithium ion secondary battery containing a positive electrode active material of Example 3;

FIG. 10 is a graph illustrating a charge-discharge curve of a lithium ion secondary battery containing a positive electrode active material of Example 4;

FIG. 11 is a graph illustrating a charge-discharge curve of a lithium ion secondary battery containing a positive electrode active material of Example 5;

FIG. 12 is a graph illustrating a charge-discharge curve of a lithium ion secondary battery containing a positive electrode active material of Comparative Example 1;

FIG. 13 is a graph illustrating a dQ/dV plot in the charge-discharge cycle of FIG. 7;

FIG. 14 is a graph illustrating a dQ/dV plot in the charge-discharge cycle of FIG. 8;

FIG. 15 is a graph illustrating a dQ/dV plot in the charge-discharge cycle of FIG. 9;

FIG. 16 is a graph illustrating a dQ/dV plot in the charge-discharge cycle of FIG. 10;

FIG. 17 is a graph illustrating a dQ/dV plot in the charge-discharge cycle of FIG. 11;

FIG. 18 is a graph illustrating a dQ/dV plot in the charge-discharge cycle of FIG. 12;

FIG. 19 is a diagram illustrating X-ray diffraction patterns of positive electrode active materials of Examples 6 to 12;

FIG. 20 is a graph illustrating a relationship between a composition of a lithium-iron composite fluoride of each of Examples 1 to 4, Examples 6 to 9, and Examples 11 and 12 and a diffraction intensity ratio (I_{LFF/FeF3}); and

FIG. 21 is a graph illustrating a charge-discharge capacity of a lithium ion secondary battery containing the positive electrode active material of each of Examples 1 to 10.

### DETAILED DESCRIPTION

Hereinafter, preferred embodiments of the present invention will be described in detail.

### [Positive Electrode Active Material]

A positive electrode active material of the present embodiment contains a lithium-iron composite fluoride as a principal component, and is used in a positive electrode of a lithium ion secondary battery. The phrase “contains a lithium-iron composite fluoride as a principal component” means that the content of the lithium-iron composite fluoride is 75% by mass or more, preferably 80% by mass or more, more preferably 90% by mass or more, and still more preferably 99% by mass or more with respect to the total mass of the positive electrode active material, and may be 100% by mass. The positive electrode active material may contain components other than the principal component as long as a function of the present invention is not impaired.

The positive electrode active material of the present embodiment may contain only one kind or two or more kinds of lithium-iron composite fluorides as long as the lithium-iron composite fluoride is contained as a principal component.

In a case where the positive electrode active material is manufactured by using the lithium-iron composite fluoride as a principal component, a total composition ratio (Li:Fe:F) of the lithium-iron composite fluoride is also maintained in the obtained positive electrode active material. In a case where the positive electrode active material obtained by using the lithium-iron composite fluoride having such a composition as a principal component is used in a secondary battery, a high-voltage operation can be achieved. In addition, the composition ratio of the lithium-iron composite fluoride is adjusted to be similar to a composition ratio required for a positive electrode active material to be obtained.

### (Lithium-Iron Composite Fluoride)

The lithium-iron composite fluoride of the present embodiment is represented by the following formula (1).

LiₓFeF₍₃₊ₓ₎ (1)

In formula (1), x is a number satisfying 0.4≤x<1.5. In formula (1), x preferably satisfies 0.4≤x<1.0, more preferably satisfies 0.4≤x≤0.9, and still more preferably satisfies 0.5≤x≤0.8. When x is within the above numerical range, a small battery having an increased average discharge voltage, an increased capacity, and a high energy density can be constructed.

In formula (1), x represents a molar ratio between Li and Fe. The molar ratio between Li and Fe is x:1. A molar ratio among Li, Fe, and F is x:1:(3+x).

A composition of the lithium-iron composite fluoride can be determined by inductively coupled plasma (ICP) optical emission spectrometry.

### <X-Ray Diffraction (XRD) Pattern>

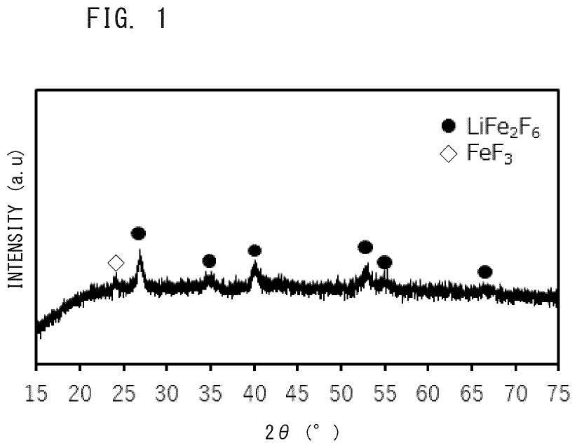

FIG. 1 illustrates, as an example of an X-ray diffraction (XRD) pattern of the positive electrode active material according to the present embodiment, an XRD pattern of Example 4 described later. As illustrated in FIG. 1, the positive electrode active material of the present embodiment preferably has peaks in a range of 20°≤2θ<25° and a range of 25°≤2θ≤30°, respectively. The peak in the range of 20° 2θ<25° represents a peak derived from a crystal structure of FeF₃ which is trivalent iron. The peak in the range of 25°≤2θ≤30° represents a peak derived from a crystal structure of LiFe₂F₆. This means that the positive electrode active material of the present embodiment has a similar crystal structure to those of FeF₃ and LiFe₂F₆. In the lithium-iron composite fluoride of the present embodiment, iron is entirely composed of Fe³⁺ in the composition ratio of LiFeF₄. Therefore, the following formula (2) is obtained as described according to a composition formula of LiFe₂F₆ of a tetragonal crystal system in a P42/mnm space group.

Li_{y}Fe₂F_{(6+y)} (2)

In formula (2), y is a number satisfying 1<y<3.

### <Diffraction Intensity Ratio>

When there are peaks in a range of 20° 2θ<25° and a range of 25°≤2θ≤30° in an XRD pattern, a diffraction intensity ratio (I_{LFF/FeF3}) represented by a maximum peak intensity in the range of 25°≤2θ≤30° to a maximum peak intensity in the range of 20≤2θ<25° preferably satisfies a relationship of the following formula (3):

I_{LFF/FeF3}=0.74x+b (3)

(Note that, in formula (3), x represents a number satisfying 0.4≤x<1.0 in the above formula (1), and b represents a number satisfying b>0.46.)

In formula (3), x represents a number satisfying 0.4≤x<1.0 in the above formula (1), preferably satisfies 0.4≤x≤0.9, and more preferably satisfies 0.5≤x≤0.8.

In formula (3), b represents a number satisfying b>0.46, preferably satisfies b≥0.48, and more preferably satisfies b≥0.50. An upper limit value of b is not particularly limited, but is preferably 2.0, for example.

When the positive electrode active material of the present embodiment satisfies the relationship of formula (3), a capacity of a lithium ion secondary battery containing the positive electrode active material can be further increased, and an energy density can be further increased.

This means that a composition ratio between the crystal structure of LiFe₂F₆ and the crystal structure of FeF₃ in the lithium-iron composite fluoride contained in the positive electrode active material of the present embodiment satisfies a certain relationship, and by controlling the composition ratio between the crystal structure of LiFe₂F₆ and the crystal structure of FeF₃ to satisfy the certain relationship, a capacity of a lithium ion secondary battery containing the positive electrode active material can be further increased, and an energy density can be further increased.

The diffraction intensity ratio (I_{LFF/FeF3}) represented by a maximum peak intensity in the range of 25°≤2θ≤30° to a maximum peak intensity in the range of 20°≤2θ<25° can be obtained by analyzing an XRD pattern.

Here, the “maximum peak intensity” means a peak intensity of a peak having a maximum peak height when there are a plurality of peaks in each of the range of 20°≤2θ<25° and the range of 25°≤2θ≤30°. When there is one peak in each of the range of 20°≤2θ<25° and the range of 25°≤2θ≤30°, a peak intensity of the peak is the “maximum peak intensity”.

Note that each “peak intensity” is given by a peak height of the peak.

### [Lithium Ion Secondary Battery]

The lithium ion secondary battery of the present embodiment includes a positive electrode, a negative electrode, and an electrolyte, and the positive electrode contains a positive electrode active material containing the above-described lithium-iron composite fluoride as a principal component. The lithium ion secondary battery of the present embodiment may include other battery elements as necessary.

In the lithium ion secondary battery of the present embodiment, a battery element of a known lithium ion secondary battery can be adopted as it is except that the positive electrode contains a positive electrode active material containing the above-described lithium-iron composite fluoride as a principal component. The lithium ion secondary battery of the present embodiment may have any of a coin type, a button type, a cylindrical type, a square type, and a laminate type. In addition, the lithium ion secondary battery of the present embodiment can be applied to a wide range of applications such as a mobile device such as a mobile phone or a laptop computer, and in-vehicle applications.

Hereinafter, as for the lithium ion secondary battery of the present embodiment, a lithium ion secondary battery (coin-type lithium ion secondary battery) using an electrolytic solution will be described. Each battery element described below can be similarly applied to an all-solid-state lithium ion secondary battery or a semi-solid lithium ion secondary battery not using an electrolytic solution.

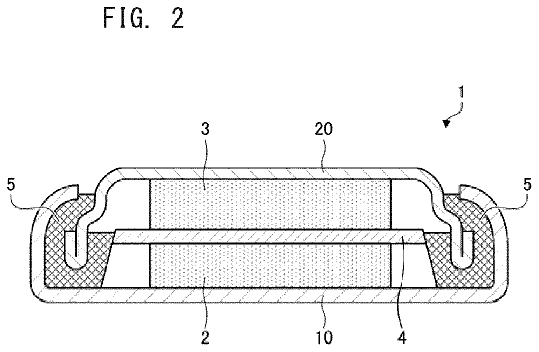

As illustrated in FIG. 2, a lithium ion secondary battery 1 of the present embodiment includes a negative electrode can (negative electrode terminal) 20, a negative electrode 3, a separator 4 impregnated with an electrolytic solution, an insulating packing (gasket) 5, a positive electrode 2, and a positive electrode can 10.

The positive electrode can 10 is disposed below the separator 4, the negative electrode can 20 is disposed above the separator 4, and the outer shape of the lithium ion secondary battery 1 is formed by the positive electrode can 10 and the negative electrode can 20. The positive electrode 2 and the negative electrode 3 are disposed between the positive electrode can 10 and the negative electrode can 20 with the separator 4 impregnated with an electrolytic solution interposed therebetween, and the positive electrode 2 and the negative electrode 3 are separated from each other by the separator 4. The positive electrode can 10 and the negative electrode can 20 are electrically insulated from each other by the insulating packing 5.

In the lithium ion secondary battery 1, the positive electrode 2 can be prepared by blending a conductive agent, a binder, and the like with the positive electrode active material of the present embodiment as necessary to prepare a positive electrode mixture, and pressing the positive electrode mixture to a current collector (not illustrated).

As the current collector, a stainless steel mesh, an aluminum foil, or the like can be preferably used. As the conductive agent, a carbon nanotube (CNT), acetylene black, Ketjenblack, or the like can be preferably used. As the binder, tetrafluoroethylene, polyvinylidene fluoride, or the like can be preferably used.

Blending ratios of the positive electrode active material, the conductive agent, and the binder in the positive electrode mixture are not particularly limited. The content of the positive electrode active material in the positive electrode mixture is preferably 75% to 100% by mass, and more preferably 90% to 99% by mass. The content of the conductive agent in the positive electrode mixture is preferably 1% to 15% by mass, and more preferably 0.1% to 5% by mass. The content of the binder in the positive electrode mixture is preferably 0.1% to 10% by mass, and more preferably 0.1% to 5% by mass.

In the lithium ion secondary battery 1, as the negative electrode 3 with respect to the positive electrode 2, a known electrode that functions as a negative electrode active material and can intercalate and release lithium, for example, a metal-based material such as metallic lithium or a lithium alloy, a carbon-based material such as graphite or mesocarbon microbeads (MCMB), and a silicon-based material such as silicon (Si), a Si alloy, or silicon oxide can be adopted. Among these materials, metallic lithium and graphite are preferable as the negative electrode 3.

Known battery elements can be adopted as the separator 4 and the battery containers (positive electrode can 10 and negative electrode can 20).

As the electrolyte, a known electrolytic solution, a known semi-solid electrolyte, a known solid electrolyte, or the like can be adopted. As the electrolytic solution, for example, a solution obtained by dissolving an electrolyte such as lithium perchlorate or lithium hexafluorophosphate in a solvent such as ethylene carbonate (EC), dimethyl carbonate (DMC), propylene carbonate (PC), or diethyl carbonate (DEC) can be used.

As the semi-solid electrolyte and the solid electrolyte, a known semi-solid electrolyte and a known solid electrolyte can be used except that a positive electrode active material containing the above-described lithium-iron composite fluoride as a principal component is used.

Examples of the semi-solid electrolyte include an electrolyte containing a polymer component and a standard electrolytic solution. Examples of the polymer component include polyvinylidene fluoride (PVDF)/polyethylene oxide (PEO), polyacrylonitrile (PAN)/PEO, polymethyl methacrylate (PMMA), PVDF/hexafluoropropylene (HFP), and other polymer components. Examples of the standard electrolytic solution include a 1 mol/L lithium hexafluorophosphate (LiPF₆) EC/DMC solution, a 1 mol/L LiPF₆ EC/ethyl methyl carbonate (EMC) solution, and a 1 mol/L LiPF₆ EC/DMC/EMC solution.

In a case of the all-solid-state lithium ion secondary battery, as the electrolyte, for example, a solid electrolyte such as a polymer-based solid electrolyte such as a polyethylene oxide-based polymer compound or a polymer compound containing at least one or more of a polyorganosiloxane chain and a polyoxyalkylene chain, a sulfide-based solid electrolyte, or an oxide-based solid electrolyte can be used.

As for the positive electrode of the all-solid-state lithium ion secondary battery, for example, a positive electrode mixture containing a solid electrolyte in addition to the positive electrode active material, the conductive agent, and the binder described above can be carried on a positive electrode current collector such as aluminum, nickel, or stainless steel.

The lithium ion secondary battery 1 of the present embodiment can operate at a high voltage because the positive electrode 2 contains the positive electrode active material of the present embodiment.

<dQ/dV Plot of Charge-Discharge Cycle>

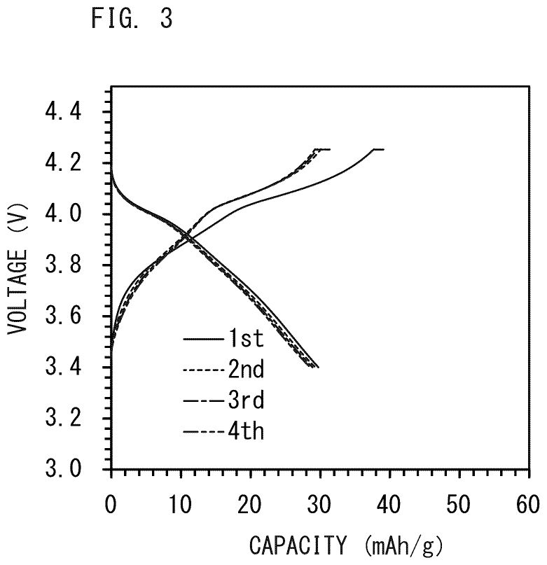

FIG. 3 illustrates a graph for Example 4 described later as an example of a charge-discharge curve in a charge-discharge cycle of the lithium ion secondary battery of the present embodiment. The horizontal axis of the graph of FIG. 3 represents a capacity of the lithium ion secondary battery. The vertical axis of the graph of FIG. 3 represents a voltage of the lithium ion secondary battery during charge and discharge. In the charge-discharge curve of FIG. 3, the right-upward curve represents a curve during charge, and the left-upward curve represents a curve during discharge. In FIG. 3, 1st, 2nd, 3rd, and 4th each represent the number of charge-discharge cycles.

The capacity of the lithium ion secondary battery illustrated in FIG. 3 is 30 mAh/g, and the voltage of the curve during discharge at 15 mAh/g, which is half the capacity, is an average discharge voltage. As illustrated in FIG. 3, the lithium ion secondary battery of the present embodiment has an average discharge voltage of about 3.8 V.

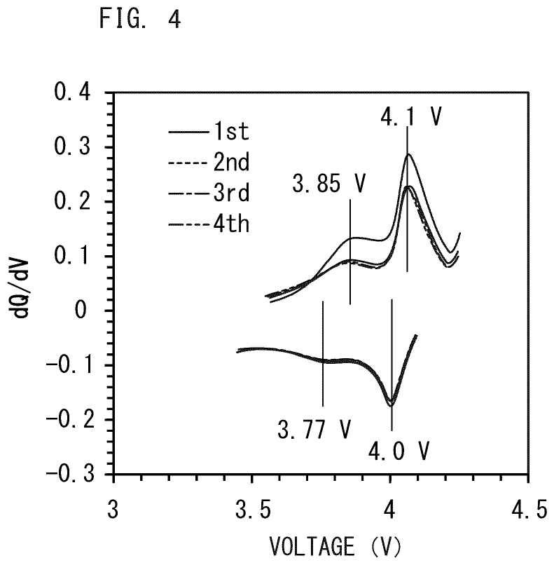

FIG. 4 illustrates a dQ/dV plot in the charge-discharge cycle of FIG. 3. The horizontal axis of the graph in FIG. 4 represents a voltage in the charge-discharge cycle. The vertical axis of the graph in FIG. 4 represents a value (dQ/dV plot, dQdV⁻¹ plot) obtained by differentiating the capacity of FIG. 3 with the voltage. In FIG. 4, the upwardly convex curve represents a curve during charge, and the downwardly convex curve represents a curve during discharge. In FIG. 4, 1st, 2nd, 3rd, and 4th each represent the number of charge-discharge cycles.

As illustrated in FIG. 4, the curve during charge has peaks at 3.85 V and 4.1 V. The curve during discharge has peaks at 3.77 V and 4.0 V. These peaks indicate that the positive electrode active material undergoes a chemical reaction in the positive electrode during charge or discharge. This indicates that the chemical reaction occurs in a high voltage range of 3.77 to 4.0 V during discharge, and the lithium ion secondary battery can operate at a high voltage.

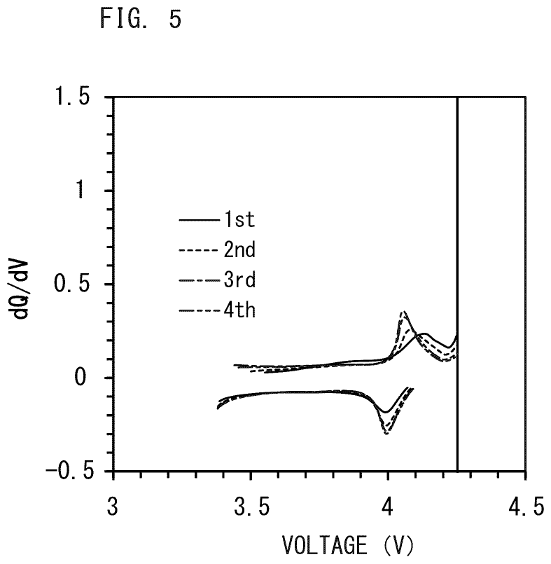

FIG. 5 illustrates a graph for Example 1 described later as an example of a dQ/dV plot in a charge-discharge cycle of a lithium ion secondary battery according to another embodiment. In FIG. 5, the upwardly convex curve represents a curve during charge, and the downwardly convex curve represents a curve during discharge. In FIG. 5, 1st, 2nd, 3rd, and 4th each represent the number of charge-discharge cycles.

The curve during discharge in Example 1 has peaks at 3.5 V, 3.77 V, and 4.0 V. A dQ/dV value of the peak at 3.5 V is −0.0708 mAhg⁻¹V⁻¹, a dQ/dV value of the peak at 3.77 V is −0.090 mAhg⁻¹V⁻¹, and a dQ/dV value of the peak at 4.0 V is −0.1634 mAhg⁻¹V⁻¹. Note that a dQ/dV value of each peak represents an average value of three charge-discharge cycles excluding the first cycle. The peak height at 3.77 V is −0.090/−0.0708=1.27 times the peak height at 3.5 V, and the peak height at 4.0 V is −0.1634/−0.0708=2.31 times the peak height at 3.5 V. Note that, in a curve during discharge in Example 3 described later, a dQ/dV value of a peak at 3.5 V is −0.107 mAhg⁻¹V⁻¹, and a dQ/dV value of a peak at 4.0 V is −0.464 mAhg⁻¹V⁻¹. In Example 3, the peak height at 4.0 V is −0.464/−0.107=4.34 times the peak height at 3.5 V. As described above, in the curves during discharge in Examples 1 and 3, the peak height at 3.77 to 4.0 V is 1.2 times to 4.4 times the peak height at 3.3 to 3.5 V. This indicates that the chemical reaction occurs at 3.77 to 4.0 V with a substance amount that is 1.2 to 4.4 times that of the chemical reaction at 3.3 to 3.5 V during discharge, and the lithium ion secondary battery can operate at a high voltage.

The average discharge voltage of the lithium ion secondary battery of the present embodiment is preferably 3.8 to 4.0 V, and more preferably 3.8 to 3.9 V. When the average discharge voltage of the lithium ion secondary battery is equal to or more than the above lower limit value, the lithium ion secondary battery can operate at a higher voltage. An upper limit value of the average discharge voltage of the lithium ion secondary battery is not particularly limited, but is substantially 4.0 V.

### [Method for Manufacturing Positive Electrode Active Material]

The positive electrode active material of the present embodiment contains the above-described lithium-iron composite fluoride as a principal component. As a lithium source of the lithium-iron composite fluoride, it is possible to use a known compound such as a halide such as lithium fluoride (LiF), a hydroxide such as lithium hydroxide monohydrate (LiOH·H₂O), a carbonate such as lithium carbonate (Li₂CO₃), or an acetate such as lithium acetate (CH₃COOLi) or lithium acetate dihydrate (CH₃COOLi·2H₂O), and there is no particular limitation.

As an iron source of the lithium-iron composite fluoride, trivalent iron is preferable rather than divalent iron, and ferric fluoride (FeF₃) is more preferable because high-voltage operation can be performed.

When the lithium-iron composite fluoride is manufactured, the above-described lithium source and iron source are mixed and subjected to a mechanical treatment under predetermined conditions for a predetermined time. For example, when lithium fluoride is used as the lithium source, and trivalent iron (FeF₃) is used as the iron source, it is considered that the compound represented by the above formula (1) can be formed by the following reaction.

LiF+FeF₃→LiFeF₄ (compound in which x=1 in the above formula (1))

A value of x in the compound represented by the above formula (1) can be adjusted by a molar ratio between LiF and FeF₃.

A specific device applied in the mechanical treatment is not particularly limited, but various devices conventionally used for the purpose of pulverizing and mixing a solid substance can be applied. Among these devices, a ball mill is preferable, and a planetary ball mill is more preferable because raw materials can be sufficiently pulverized and mixed.

A time for performing the mechanical treatment is preferably, for example, 8 to 12 hours, and more preferably 9 to 11 hours.

As a condition for performing the mechanical treatment, a rotation speed is preferably 250 to 450 rpm, and more preferably 300 to 400 rpm.

A temperature at which the mechanical treatment is performed is not particularly limited, and the mechanical treatment can be performed at room temperature (for example, 5° C. to 30° C.).

An atmosphere for the mechanical treatment is preferably an inert gas (a rare gas such as argon (Ar), a nitrogen (N₂) gas, or the like)

The lithium-iron composite fluoride obtained by the mechanical treatment is preferably subjected to a heat treatment. By subjecting the lithium-iron composite fluoride to the heat treatment, a crystal structure in the lithium-iron composite fluoride changes, and a capacity of a lithium ion secondary battery using the lithium-iron composite fluoride as a positive electrode active material can be increased.

This is considered to be because a composition ratio between a crystal structure of LiFe₂F₆ and a crystal structure of FeF₃ in the lithium-iron composite fluoride changes by the heat treatment, and the crystal structure of LiFe₂F₆ increases.

By subjecting the lithium-iron composite fluoride to the heat treatment, a lithium-iron composite fluoride satisfying the above-described relationship of formula (3) is obtained, and a capacity of a lithium ion secondary battery containing the lithium-iron composite fluoride as a positive electrode active material can be further increased, and an energy density can be further increased.

A firing temperature in the heat treatment is preferably 100 to 300° C., more preferably 150 to 250° C., and still more preferably 175 to 225° C.

A firing time in the heat treatment is preferably 0.5 to 20 hours, more preferably 2 to 15 hours, and still more preferably 4 to 8 hours.

An atmosphere in the heat treatment is preferably an inert gas (a rare gas such as argon (Ar), a nitrogen (N₂) gas, or the like)

A pressure in the heat treatment may be normal pressure (0.1013 MPa), but is preferably low vacuum (for example, 10² Pa to 10⁵ Pa).

Note that carbon coating described later may be performed before the heat treatment.

After the compound represented by formula (1) is obtained by the mechanical treatment, it is preferable to perform carbon coating by pulverizing and mixing the compound represented by formula (1) together with carbon fine particles from a viewpoint of improving a capacity and rate characteristics. As the carbon fine particles, for example, a carbon nanotube (CNT), acetylene black, Ketjenblack, or the like can be used. Among these carbon fine particles, the CNT is preferable from a viewpoint of further improving conductivity of the positive electrode active material.

As pulverizing and mixing conditions during carbon coating, similar time and conditions to those of the mechanical treatment described above can be applied.

By preparing a lithium ion secondary battery with the obtained positive electrode active material as a positive electrode, a battery that operates at a high voltage can be obtained.

### EXAMPLES

Hereinafter, Examples of the present invention will be described, but the present invention is not limited to Examples below.

### Example 1

(Preparation of Li_{0.6}FeF_{3.6} (Compound in which x=0.6 in Formula (1))

By using a planetary ball mill machine, 0.439 g of ferric fluoride (FeF₃) and 0.0606 g of lithium fluoride (LiF) were subjected to a mechanical treatment. As the planetary ball mill machine, Premium line PL-7 manufactured by Fritsch GmbH was used. A pot and balls were made of zirconium oxide, and 50 g of the balls with a diameter of 5 mm was used in the 45 mL pot. Treatment conditions of the mechanical treatment were 350 rpm and 10 hours. Thereafter, 0.55 g of carbon nanotube (CNT) was added into the pot, and the mechanical treatment was further performed to obtain a positive electrode active material. Treatment conditions of the mechanical treatment in obtaining the positive electrode active material were 25° C., 350 rpm, and 10 hours in an Ar atmosphere.

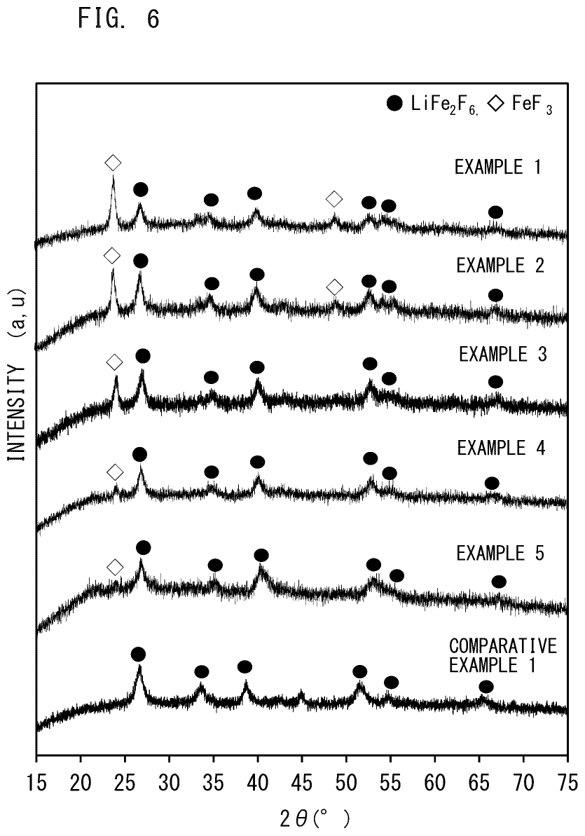

The obtained positive electrode active material was subjected to X-ray diffraction measurement according to the following measurement conditions. Results thereof are illustrated in FIG. 6.

### <<X-Ray Diffraction Measurement Conditions>>

X-ray diffractometer: SmartLab manufactured by Rigaku Corporation
X-ray source: CuKα radiation (CuKα=1.5418 Å)
Opening angle of incident parallel slit: 5.0°
Length of incident longitudinal limiting slit: 5.0 mm
Opening angle of receiving parallel slit: 5.0°
Kβ filter: Used
Step width: 0.01°
Incident slit: 1/6°
Receiving slit 1: 4.0 mm
Receiving slit 2: 13 mm

As illustrated in FIG. 6, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

### Example 2

(Preparation of Li_{0.7}FeF_{3.7} (Compound in which x=0.7 in Formula (1))

A positive electrode active material was obtained in a similar manner to Example 1 except that 0.431 g of ferric fluoride (FeF₃) and 0.0693 g of lithium fluoride (LiF) were subjected to the mechanical treatment by using a planetary ball mill machine.

The obtained positive electrode active material was subjected to X-ray diffraction measurement under similar conditions to those in Example 1. Results thereof are illustrated in FIG. 6.

As illustrated in FIG. 6, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

### Example 3

(Preparation of Li_{0.6}FeF_{3.8} (Compound in which x=0.8 in Formula (1))

A positive electrode active material was obtained in a similar manner to Example 1 except that 0.422 g of ferric fluoride (FeF₃) and 0.078 g of lithium fluoride (LiF) were subjected to the mechanical treatment by using a planetary ball mill machine.

The obtained positive electrode active material was subjected to X-ray diffraction measurement under similar conditions to those in Example 1. Results thereof are illustrated in FIG. 6.

As illustrated in FIG. 6, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

### Example 4

(Preparation of LiFeF₄ (Compound in which x=1.0 in Formula (1))

A positive electrode active material was obtained in a similar manner to Example 1 except that 0.407 g of ferric fluoride (FeF₃) and 0.0934 g of lithium fluoride (LiF) were subjected to the mechanical treatment by using a planetary ball mill machine.

The obtained positive electrode active material was subjected to X-ray diffraction measurement under similar conditions to those in Example 1. Results thereof are illustrated in FIG. 6.

As illustrated in FIG. 6, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

### Example 5

(Preparation of Li_{1.2}FeF_{4.2}(Compound in which x=1.2 in Formula (1))

A positive electrode active material was obtained in a similar manner to Example 1 except that 0.391 g of ferric fluoride (FeF₃) and 0.108 g of lithium fluoride (LiF) were subjected to the mechanical treatment by using a planetary ball mill machine.

The obtained positive electrode active material was subjected to X-ray diffraction measurement under similar conditions to those in Example 1. Results thereof are illustrated in FIG. 6.

As illustrated in FIG. 6, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

### Comparative Example 1

### (Preparation of LiFeF₃)

A positive electrode active material was obtained in a similar manner to Example 1 except that 0.392 g of ferrous fluoride (FeF₂) and 0.108 g of lithium fluoride (LiF) were subjected to the mechanical treatment by using a planetary ball mill machine.

The obtained positive electrode active material was subjected to X-ray diffraction measurement under similar conditions to those in Example 1. Results thereof are illustrated in FIG. 6.

As illustrated in FIG. 6, a diffraction pattern of the obtained positive electrode active material coincided with a diffraction pattern of LiFe₂F₆ of a tetragonal crystal system in a P42/mnm space group with DB card number 01-074-2193, and it was found that the obtained positive electrode active material had a crystal structure similar to that of LiFe₂F₆.

### [Preparation of Lithium Ion Secondary Battery]

### (Preparation of Positive Electrode)

By dispersing 80 parts by mass of the positive electrode active material obtained in each of Examples 1 to 5 and Comparative Example 1, 10 parts by mass of acetylene black, and 10 parts by mass of polyvinylidene fluoride in N-methylpyrrolidone as a solvent, a slurry (positive electrode mixture) containing, as solid contents, 80% by mass of the positive electrode active material, 10% by mass of acetylene black, and 10% by mass of polyvinylidene fluoride was prepared. This slurry was applied onto an aluminum foil, pressed at 15 tons, and then punched with a puncher having a diameter of 10 mm to prepare a positive electrode. At this time, the mass of the positive electrode active material was adjusted to 3.5 mg.

### (Preparation of Coin-Type Cell)

The prepared positive electrode (diameter: 10 mm) was placed on a positive electrode can, a porous polyethylene film serving as a separator was placed thereon, and the resulting product was pressed with a polypropylene gasket.

Thereafter, a Li negative electrode having a thickness of 0.5 mm was placed thereon, and a spacer for thickness adjustment was placed thereon. Thereafter, as a non-aqueous electrolytic solution, a mixed solvent of ethylene carbonate and diethyl carbonate (volume ratio: 5: 5) in which 1 mol/L lithium hexafluorophosphate was dissolved was added between the positive electrode can and the negative electrode, the separator was impregnated with the mixed solvent, and a negative electrode can was placed thereon and sealed to prepare a coin-type cell (lithium ion secondary battery).

### [Evaluation of Battery Performance]

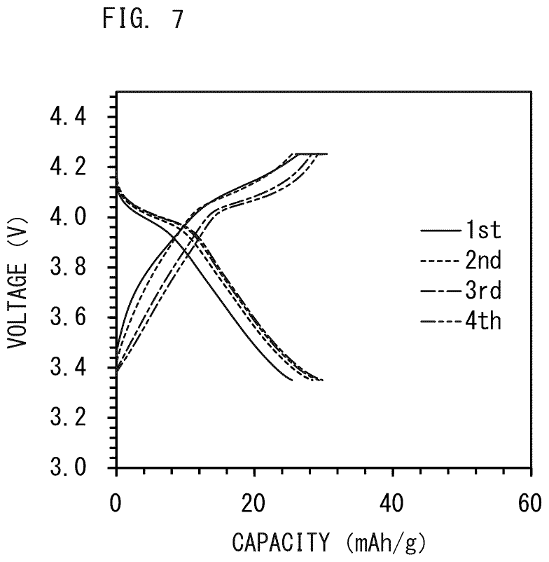

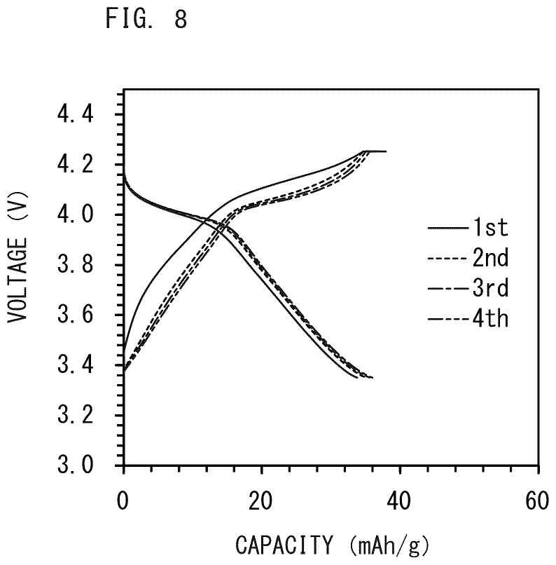

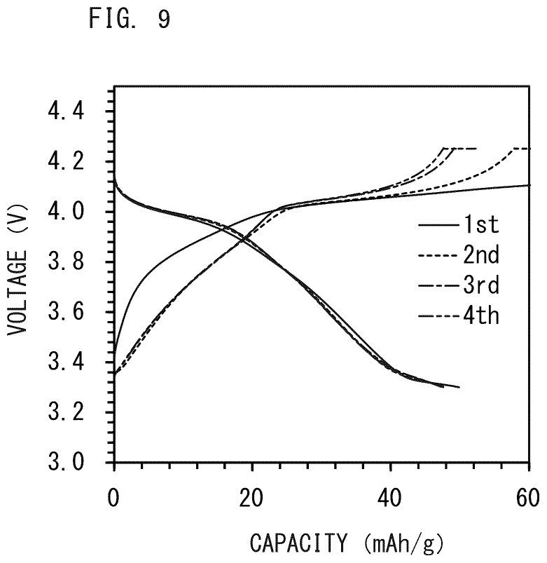

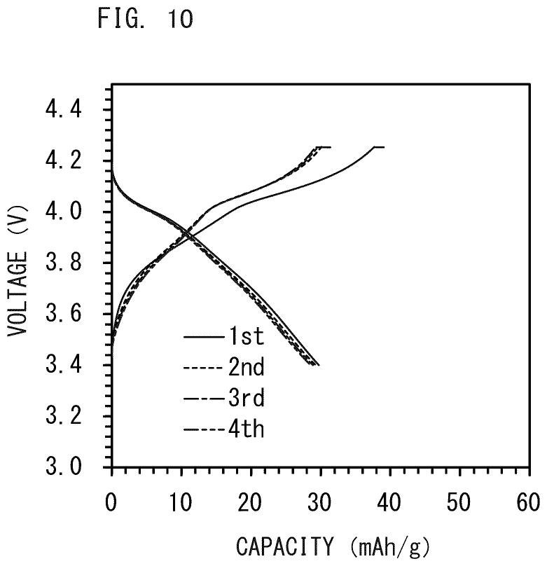

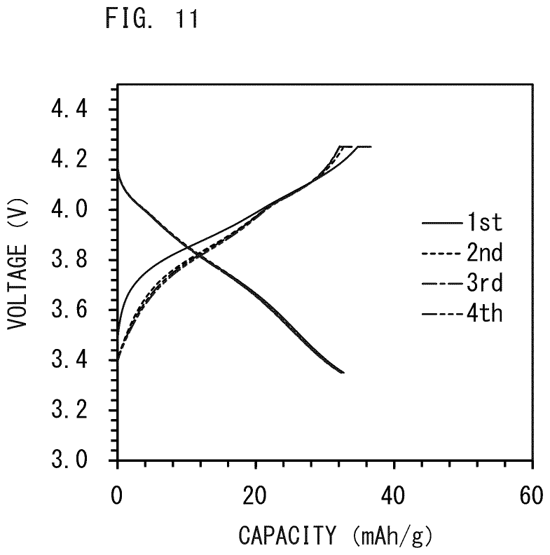

Battery performance of the prepared coin-type cell was evaluated. Specifically, the prepared coin-type cell was charged and discharged at a constant current having a current value of 5 mA/g per mass of the positive electrode active material. During charge and discharge at a constant current, an upper limit voltage was 4.25 V, and a lower limit voltage was 3.35 V. A resting time after charge and discharge was 10 minutes. A charge-discharge capacity (mAh/g) was calculated per unit mass of the positive electrode active material. Charge-discharge curves of charge and discharge at a constant current in Examples 1 to 5 and Comparative Example 1 are illustrated in FIGS. 7 to 12, respectively.

In Examples 1 to 5 to which the present invention was applied, energy densities were 113 Wh/kg, 136 Wh/kg, 175 Wh/kg, 108 Wh/kg, and 119 Wh/kg, respectively. As illustrated in FIGS. 7 to 11, in Examples 1 to 5 to which the present invention was applied, average discharge voltages were 3.76 V, 3.79 V, 3.73 V, 3.79 V, and 3.72 V, respectively. As described above, in Examples 1 to 5 to which the present invention was applied, it was confirmed that the energy density and the average discharge voltage were high, and a high energy density and high-voltage operation could be achieved.

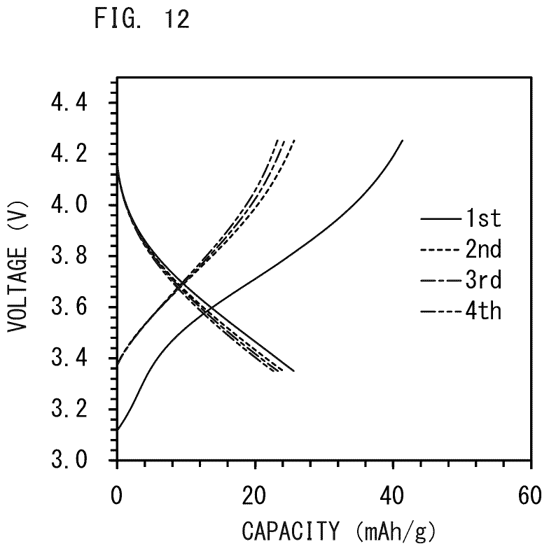

In contrast, in Comparative Example 1 (LiFeF₃) in which the positive electrode active material did not contain the compound represented by formula (1), the energy density was 87 Wh/kg, and as illustrated in FIG. 12, the average discharge voltage was 3.64 V.

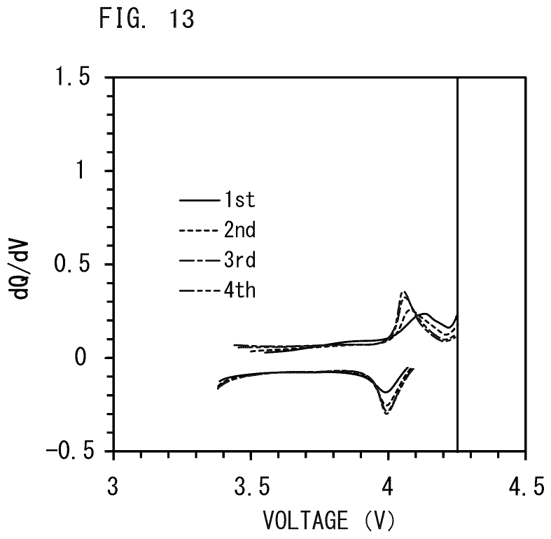

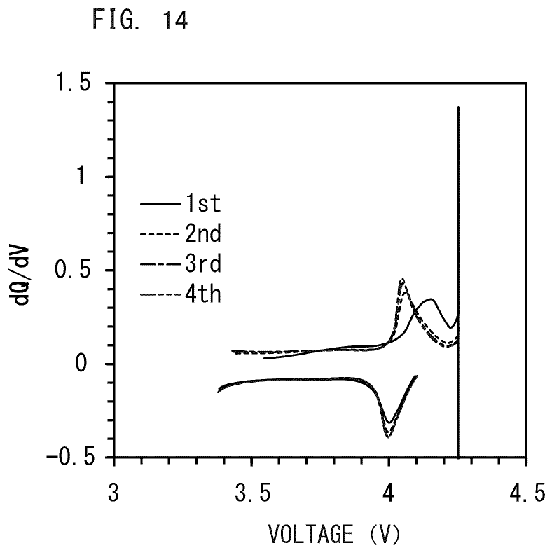

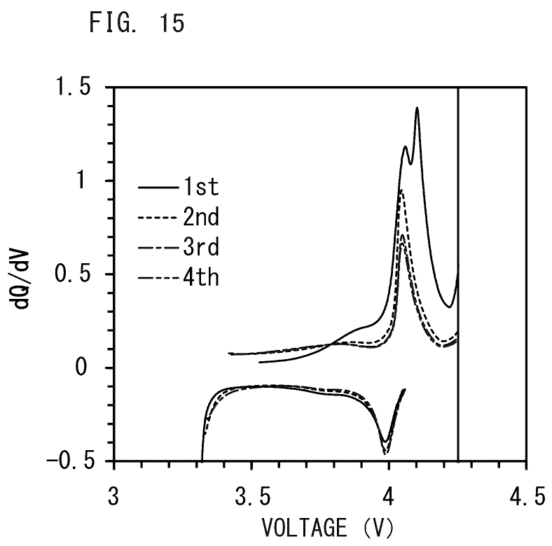

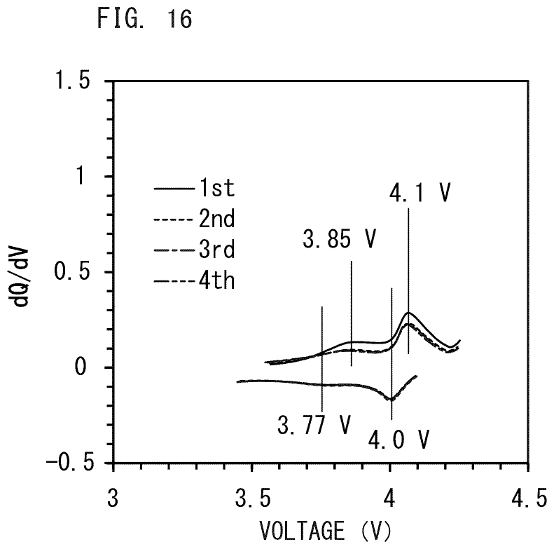

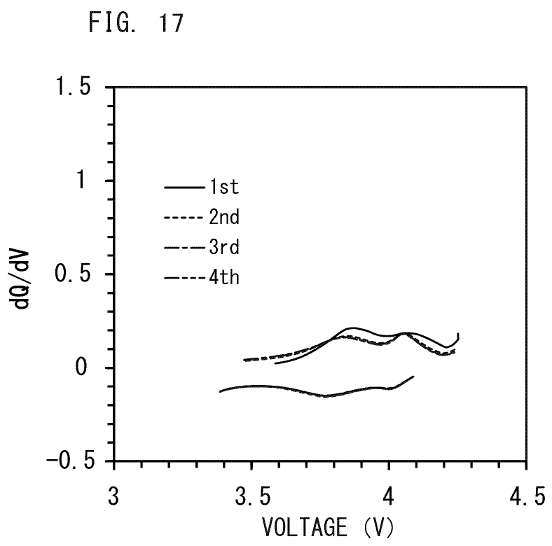

From each of the obtained charge-discharge curves, a dQ/dV plot was created with the horizontal axis representing a voltage and the vertical axis representing a value obtained by differentiating a capacity with the voltage (dQ/dV, dQdV⁻¹), and a voltage at which a chemical reaction occurred (reaction voltage) was determined from a peak voltage of the dQ/dV plot during discharge. The dQ/dV plots in Examples 1 to 5 and Comparative Example 1 are illustrated in FIGS. 13 to 18, respectively.

As illustrated in FIGS. 13 to 17, in each of Examples 1 to 5 to which the present invention was applied, a peak voltage of the dQ/dV plot during discharge was as high as 3.77 V to 4.0 V, and it was confirmed that the chemical reaction occurred at a high voltage inherent to the compound represented by formula (1).

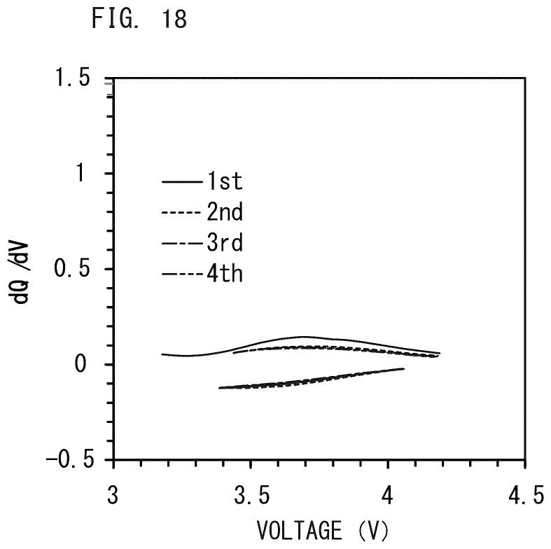

On the other hand, in Comparative Example 1 (LiFeF₃) in which the positive electrode active material did not contain the compound represented by formula (1), as illustrated in FIG. 18, a peak voltage of the dQ/dV plot during discharge was not observed around 4 V, and only a broad peak was observed in the operating voltage range. It is considered that in order to observe a clear reaction of Fe²⁺/Fe³⁺, it is necessary to lower a lower limit of the operating voltage range, and in Comparative Example 1, a chemical reaction occurs at a voltage lower than the lower limit voltage of 3.35 V of the present Examples.

### Example 6

The positive electrode active material obtained in Example 1 was subjected to a heat treatment at 103 Pa in an argon gas atmosphere at 200° C. using an oven for five hours.

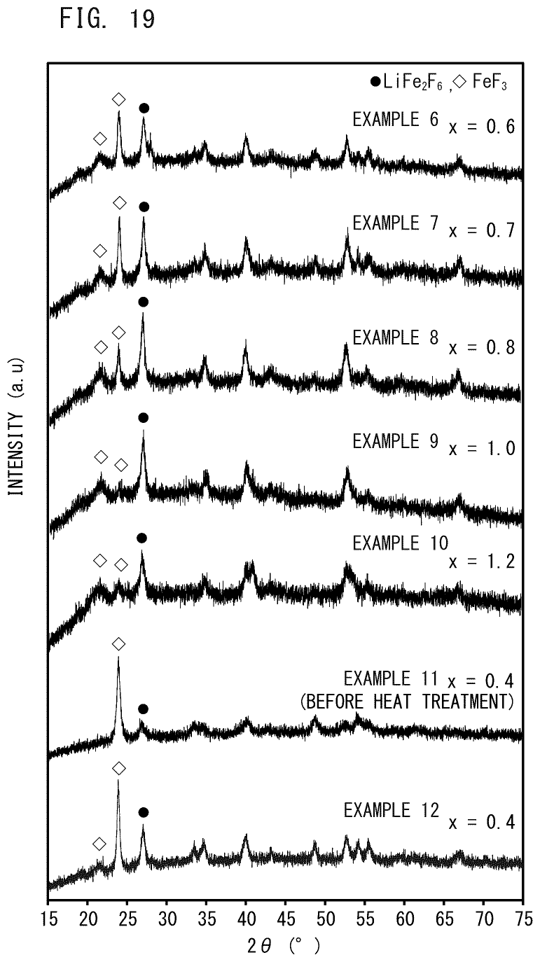

The obtained positive electrode active material was subjected to X-ray diffraction measurement under similar conditions to those in Example 1. Results thereof are illustrated in FIG. 19.

As illustrated in FIG. 19, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

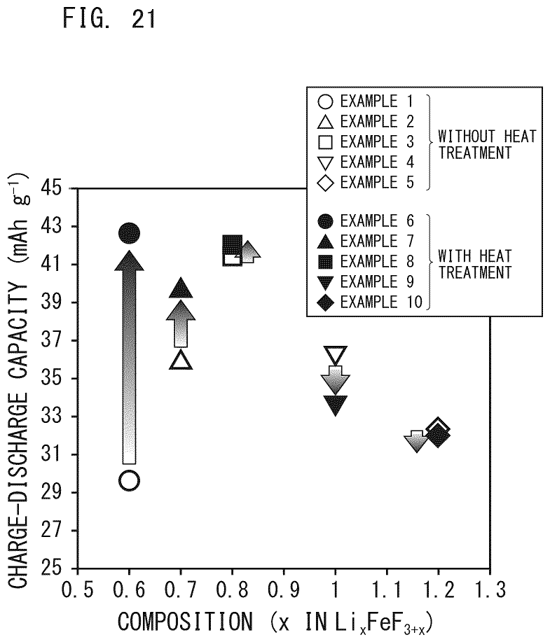

Next, using the positive electrode active material after the heat treatment, a coin-type cell was prepared in a similar manner to Example 1, and a capacity thereof during charge and discharge was measured. Results thereof are illustrated in FIG. 21. Note that a capacity when the heat treatment is not performed is indicated by “◯”.

### Example 7

The positive electrode active material obtained in Example 2 was subjected to a heat treatment under similar conditions to Example 6, and the obtained positive electrode active material was subjected to X-ray diffraction measurement under similar conditions to Example 1. Results thereof are illustrated in FIG. 19.

As illustrated in FIG. 19, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

Next, using the positive electrode active material after the heat treatment, a coin-type cell was prepared in a similar manner to Example 1, and a capacity thereof during charge and discharge was measured. Results thereof are illustrated in FIG. 21. Note that a capacity when the heat treatment is not performed is indicated by “A”.

### Example 8

The positive electrode active material obtained in Example 3 was subjected to a heat treatment under similar conditions to Example 6, and the obtained positive electrode active material was subjected to X-ray diffraction measurement under similar conditions to Example 1. Results thereof are illustrated in FIG. 19.

As illustrated in FIG. 19, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

Next, using the positive electrode active material after the heat treatment, a coin-type cell was prepared in a similar manner to Example 1, and a capacity thereof during charge and discharge was measured. Results thereof are illustrated in FIG. 21. Note that a capacity when the heat treatment is not performed is indicated by “□”.

### Example 9

The positive electrode active material obtained in Example 4 was subjected to a heat treatment under similar conditions to Example 6, and the obtained positive electrode active material was subjected to X-ray diffraction measurement under similar conditions to Example 1. Results thereof are illustrated in FIG. 19.

As illustrated in FIG. 19, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

Next, using the positive electrode active material after the heat treatment, a coin-type cell was prepared in a similar manner to Example 1, and a capacity thereof during charge and discharge was measured. Results thereof are illustrated in FIG. 21. Note that a capacity when the heat treatment is not performed is indicated by “V”.

### Example 10

The positive electrode active material obtained in Example 5 was subjected to a heat treatment under similar conditions to Example 6, and the obtained positive electrode active material was subjected to X-ray diffraction measurement under similar conditions to Example 1. Results thereof are illustrated in FIG. 19.

As illustrated in FIG. 19, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

Next, using the positive electrode active material after the heat treatment, a coin-type cell was prepared in a similar manner to Example 1, and a capacity thereof during charge and discharge was measured. Results thereof are illustrated in FIG. 21. Note that a capacity when the heat treatment is not performed is indicated by “O”.

### Example 11

(Preparation of Li_{0.4}FeF_{3.4} (Compound in which x=0.4 in Formula (1))

A positive electrode active material was obtained in a similar manner to Example 1 except that 0.458 g of ferric fluoride (FeF₃) and 0.0421 g of lithium fluoride (LiF) were subjected to the mechanical treatment by using a planetary ball mill machine.

The obtained positive electrode active material was subjected to X-ray diffraction measurement under similar conditions to those in Example 1. Results thereof are illustrated in FIG. 19.

As illustrated in FIG. 19, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

### Example 12

The positive electrode active material obtained in Example 11 was subjected to a heat treatment under similar conditions to Example 6, and the obtained positive electrode active material was subjected to X-ray diffraction measurement under similar conditions to Example 1. Results thereof are illustrated in FIG. 19.

As illustrated in FIG. 19, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

(Diffraction Intensity Ratio of Positive Electrode Active Material with Heat Treatment)

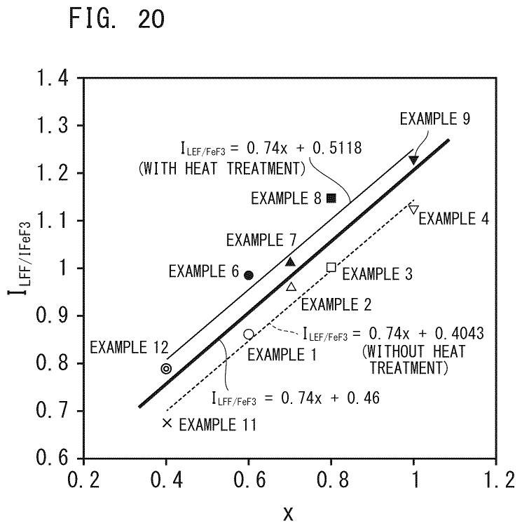

Each of the positive electrode active materials subjected to the heat treatment in Examples 6 to 9 and Example 12 was subjected to X-ray diffraction measurement under similar measurement conditions to those in Example 1. A diffraction intensity ratio (I_{LFF/FeF3}) represented by a maximum peak intensity in a range of 25°≤2θ≤30° to a maximum peak intensity in a range of 20°≤2θ<25° was obtained by analyzing an obtained XRD pattern, and a value of the diffraction intensity ratio ((I_{LFF/FeF3}) to a value of x in formula (1) was plotted. FIG. 20 illustrates an approximate curve obtained from the plots for the above 5 points and an approximate formula.

(Diffraction Intensity Ratio of Positive Electrode Active Material without Heat Treatment)

Each of the positive electrode active materials obtained in Examples 1 to 4 and Example 11 was subjected to X-ray diffraction measurement under similar measurement conditions to those in Example 1. From an obtained XRD pattern, plotting was performed in a similar manner to that in the case of the “diffraction intensity ratio of the positive electrode active material with heat treatment” to obtain an approximate curve and an approximate formula, which are illustrated in FIG. 20.

As illustrated in FIG. 20, it was confirmed that the approximate curve with heat treatment was located above a straight line (I_{LFF/FeF3}=0.74x+0.46) indicated by a thick line, and satisfied a relationship of the following formula (3).

I_{LFF/FeF3}=0.74x+b (3)

(Note that, in formula (3), x represents a number satisfying 0.4≤x<1.0 in the above formula (1), and b represents a number satisfying b>0.46.)

On the other hand, the approximate curve without heat treatment was located below the straight line (I_{LFF/FeF3}=0.74x+0.46) indicated by the thick line, and did not satisfy the relationship of the above formula (3).

This means that a value of the diffraction intensity ratio (I_{LFF/FeF3}) increases by subjecting the lithium-iron composite fluoride to the heat treatment, and it is considered that this means that the crystal structure of LiFe₂F₆ in the lithium-iron composite fluoride increases.

As illustrated in FIG. 21, in the lithium ion secondary battery using the positive electrode active material of each of Examples 6 to 8, it was confirmed that the charge-discharge capacity increased by the heat treatment. In particular, in Example 6, the charge-discharge capacity increased from 29.6 mAhg⁻¹ to 42.6 mAhg⁻¹ (1.44 times).

On the other hand, in the lithium ion secondary battery using the positive electrode active material of each of Examples 9 and 10, the charge-discharge capacity decreased by the heat treatment.

As described above, there was a difference in effect of the heat treatment depending on the composition of the lithium-iron composite fluoride contained in the positive electrode active material (a value of x in formula (1)), and the effect of the heat treatment was confirmed in a case of 0.4≤x<1.0.

From the above-described results, it has been found that the present invention can provide an Fe-based positive electrode active material capable of operating at a high voltage, and a lithium ion secondary battery containing the positive electrode active material.

In addition, it has been found that by subjecting the positive electrode active material of the present invention to a heat treatment, a capacity of a lithium ion secondary battery containing the positive electrode active material can be increased.

What is claimed is:

1. A positive electrode active material comprising a lithium-iron composite fluoride as a principal component, wherein
the lithium-iron composite fluoride is represented by the following formula (1):
LiₓFeF₍₃₊ₓ₎ (1)
where, in formula (1), x is a number satisfying 0.4≤x<1.5.

2. The positive electrode active material according to claim 1, wherein in the above formula (1), x satisfies 0.4≤x<1.0.

3. The positive electrode active material according to claim 1, having peaks in a range of 20°≤2θ<25° and a range of 25°≤2θ≤30° in an X-ray diffraction pattern.

4. The positive electrode active material according to claim 2, having peaks in a range of 20°≤2θ<25° and a range of 25°≤2θ≤30° in an X-ray diffraction pattern, wherein
a diffraction intensity ratio (I_{LFF/FeF3}) represented by a maximum peak intensity in the range of 25°≤2θ≤30° to a maximum peak intensity in the range of 20°≤2θ<25° satisfies a relationship of the following formula (3):
I_{LFF/FeF3}=0.74x+b (3)
where, in formula (3), x represents a number satisfying 0.4≤x<1.0 in the above formula (1), and b represents a number satisfying b>0.46.

5. A lithium ion secondary battery comprising a positive electrode, a negative electrode, and an electrolyte, wherein the positive electrode contains the positive electrode active material according to claim 1.

6. The lithium ion secondary battery according to claim 5, wherein a dQ/dV plot during discharge in a charge-discharge cycle has a peak in a range of 3.77 to 4.0 V.

7. The lithium ion secondary battery according to claim 5, having an average discharge voltage of 3.8 to 4.0 V.

8. The lithium ion secondary battery according to claim 5, wherein the electrolyte is a liquid electrolyte, a solid electrolyte, or a semi-solid electrolyte.

9. The lithium ion secondary battery according to claim 5, wherein the negative electrode is formed of metallic lithium or graphite.

10. A method for manufacturing the positive electrode active material according to claim 1, the method comprising a step of mixing a lithium source and an iron source, and subjecting the mixture to a mechanical treatment to obtain a lithium-iron composite fluoride.

11. The method for manufacturing the positive electrode active material according to claim 10, further comprising a step of subjecting the lithium-iron composite fluoride to a heat treatment.
